(19) United States
(12) Patent Application Publication
(10) Pub. No.: US 2026/0159174 A1
(43) Pub. Date: Jun. 11, 2026

(54) VEHICLE

(71) Applicant: Toyota Jidosha Kabushiki Kaisha, Toyota-shi (JP)

(72) Inventor: Takayoshi SHIGIHARA, Toyota-shi (JP)

(73) Assignee: Toyota Jidosha Kabushiki Kaisha, Toyota-shi (JP)

(21) Appl. No.: 19/365,611

(22) Filed: Oct. 22, 2025

(30) Foreign Application Priority Data
Dec. 10, 2024 (JP) 2024-215903

(51) Int. Cl. B62D 23/00; B60K 1/04

(52) U.S. Cl. CPC B62D 23/00; B60K 1/04; B60K 2001/0438

(57) ABSTRACT

In the vehicle, a rigidity balance between a front and a rear of the vehicle is adjusted such that a node of torsional deformation, which occurs when the vehicle is steered, is positioned within a range in the front-rear direction of a driver's seat. The vehicle further includes a battery that is disposed under the floor of the vehicle, a plurality of side fastening points for fastening the battery to a frame of the vehicle are provided at both ends of the battery in a vehicle width direction, and a density of the side fastening points on a rear side of a center of the battery in the front-rear direction is higher than a density of the side fastening points on a front side of the center of the battery in the front-rear direction.

### CROSS-REFERENCE TO RELATED APPLICATION

This application claims priority to Japanese Patent Application No. 2024-215903 filed on Dec. 10, 2024. The disclosure of the above-identified application, including the specification, drawings, and claims, is incorporated by reference herein in its entirety.

### BACKGROUND

### 1. Technical Field

The present specification discloses a vehicle that can suppress displacement vibration of a driver's seat.

### 2. Description of Related Art

As is well known, a vehicle vibrates or twists during driving. In the related art, many techniques for suppressing such vibration or twisting have been proposed. For example, Japanese Unexamined Patent Application Publication No. 2002-356180 (JP 2002-356180 A) discloses a technique for setting the rigidity of a body mount disposed at a plurality of locations on a frame of a vehicle such that a node position of a bending vibration mode of the frame coincides with a point of application of a load from a wheel to the frame. With such a configuration, the contribution of a natural vibration mode in vibration can be reduced, and thus it is possible to suppress the amplification of the vibration of a skeletal member of the vehicle.

### SUMMARY

However, in the case of the technique of JP 2002-356180 A, the torsional deformation of the vehicle accompanying the steering of the vehicle has not been sufficiently studied. In a case where the vehicle torsionally deforms, displacement vibration of the driver's seat occurs, and the driver feels uncomfortable.

Therefore, the present specification discloses a vehicle that can further improve the comfort of a driver.

In a vehicle disclosed in the present specification, a rigidity balance between the front and the rear of the vehicle is adjusted such that a node of torsional deformation that occurs when the vehicle is steered is positioned within a range of a driver's seat assembly in in a vehicle front-rear direction.

With such a configuration, in a case where the vehicle torsionally deforms, it is possible to reduce displacement vibration felt by the driver to a small level, and thus it is possible to further improve the comfort of the driver.

In this case, a weight balance between the front and the rear of the vehicle may be adjusted such that the position of the center of gravity of the vehicle in the vehicle front-rear direction is positioned within the range of the driver's seat assembly in the vehicle front-rear direction.

With such a configuration, the displacement vibration can be further reduced, and thus the comfort of the driver can be further improved.

In addition, the vehicle may further include a battery that is disposed under a floor of the vehicle. A plurality of side fastening points for fastening the battery to a frame of the vehicle may be provided at both ends of the battery in a vehicle width direction, and the density of the side fastening points rearward of the center of the battery in the front-rear direction may be higher than the density of the side fastening points forward of the center of the battery in the front-rear direction.

By increasing the number of fastening points on the rear side, the rigidity of the vehicle on the rear side is increased, and the node can be brought closer to the driver's seat.

In addition, a plurality of front fastening points and a plurality of rear fastening points for fastening the battery to the frame of the vehicle may be provided at a front end and a rear end of the battery, respectively, and a density of the front fastening points and the rear fastening points may be higher than the density of the side fastening points forward of the center of the battery in the front-rear direction.

Forces from suspension members are applied to the front fastening points and the rear fastening points. By increasing the number of front fastening points and rear fastening points, the forces applied from the suspension members are distributed.

In addition, the vehicle may further include a front body that includes a pair of wheel houses and is integrally molded by casting, a rear body that includes a pair of wheel houses and is integrally molded by a casting, a battery that is disposed under the floor of the vehicle, and a motor that is disposed rearward of the driver's seat assembly.

With such a disposition, the rigidity balance and weight balance of the vehicle are easily achieved, and the node and the center of gravity can be brought closer to the driver's seat.

According to the technique disclosed in the present specification, displacement vibration of the seat caused by the torsional deformation is suppressed, and thus the comfort of the driver is further improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a vehicle;

FIG. 2 is a schematic plan view of a frame, a body, and a battery of the vehicle;

FIG. 3 is a diagram showing a change in a steering angle θ in a case where the vehicle is lane-changed to the left-side lane;

FIG. 4 is a graph showing an amount of deformation of the frame of the vehicle at a timing t1;

FIG. 5 is a schematic diagram showing a positional relationship between a center of gravity, a node, and a seat of the vehicle; and

FIG. 6 is a perspective view showing an example of a front body.

### DETAILED DESCRIPTION OF EMBODIMENTS

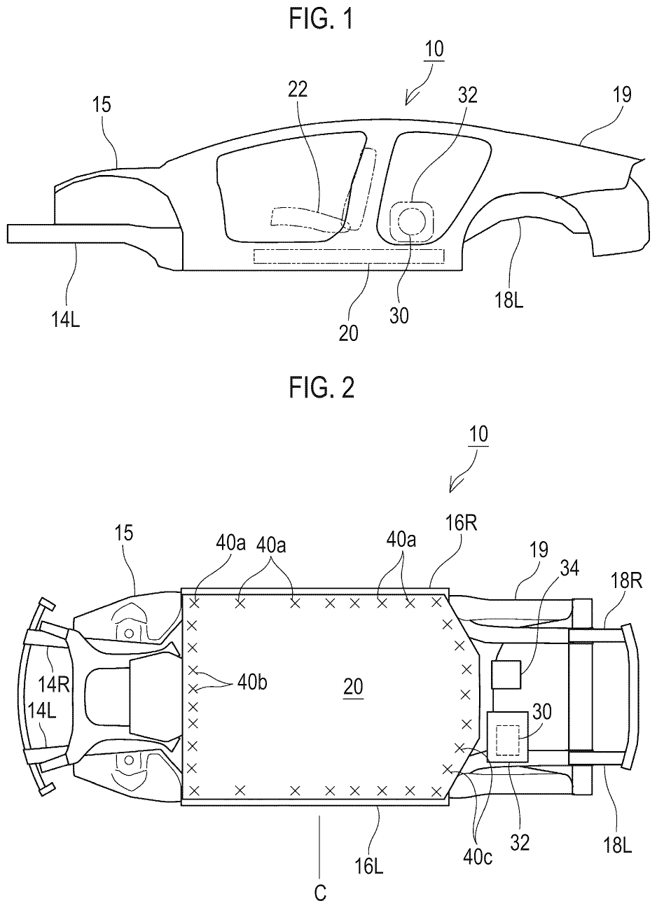

Hereinafter, a structure of a vehicle 10 will be described with reference to the drawings. FIG. 1 is a schematic side view of the vehicle 10. In addition, FIG. 2 is a schematic plan view of a frame, a body, and a battery 20 of the vehicle 10. The vehicle 10 is a two-seat vehicle and includes two seats 22 arranged side by side in the right-left direction (only one of which is visible in FIG. 1). One of the two seats 22 is a driver's seat, and the other is a passenger seat. In addition, the vehicle 10 is a battery electric vehicle that drives a motor 30 with power stored in the battery 20 to cause the vehicle 10 to travel.

The vehicle 10 includes front members 14R, 14L, rockers 16R, 16L, and rear members 18R, 18L. The front members 14R, 14L are frames that extend in a front-rear direction of the vehicle 10 at a front portion of the vehicle 10. The two front members 14R, 14L are arranged left and right symmetrically with an interval therebetween in the vehicle width direction. A front body 15 including wheel houses is attached to the two front members 14R, 14L.

The rockers 16R, 16L are frames that extend in the front-rear direction of the vehicle 10 at a central portion of the vehicle 10. The rockers 16R, 16L are both arranged left and right symmetrically with an interval therebetween in the vehicle width direction, similarly to the front members 14R, 14L. The rear members 18R, 18L are frames that extend in the front-rear direction of the vehicle 10 at a rear portion of the vehicle 10. The rear members 18R, 18L are also arranged left and right symmetrically with an interval therebetween in the vehicle width direction, similarly to the front members 14R, 14L. In addition, a rear body 19 including wheel houses is attached to the two rear members 18R, 18L. In addition, the vehicle 10 also includes a plurality of cross members (not shown) that are spanned between the two frames arranged on the left and right.

In the present example, a transaxle 32 including the motor 30 is disposed at the rear portion of the vehicle 10 behind the seat 22. In addition, a power control unit 34 (see FIG. 2) that controls charging and discharging of the battery 20 is also disposed behind the seat 22. The transaxle 32 and the power control unit 34 are disposed as described above, but the disposition thereof is determined in consideration of the weight balance of the vehicle, which will be described later.

The battery 20 stores power to be supplied to the motor 30. The battery 20 in the present example is a secondary battery that can be charged and discharged. For example, the battery 20 is a lithium ion battery. In order to ensure a sufficient cruising range, the vehicle 10 includes a large-sized flat-shaped battery 20. For example, a planar size of the battery 20 is at least about the same as that of a floor surface of the vehicle cabin. The battery 20 is disposed under the floor of the vehicle cabin and is attached to the frame of the vehicle. More specifically, the battery 20 is fastened and fixed to the rockers 16R, 16L and the cross members. In FIG. 2, cross marks indicate fastening points 40 for fastening the battery 20 to the frame of the vehicle. As shown in FIG. 2, the battery 20 is fastened to the frame of the vehicle at a peripheral edge thereof. The density of the fastening points 40 for each location is determined in consideration of the rigidity of the vehicle.

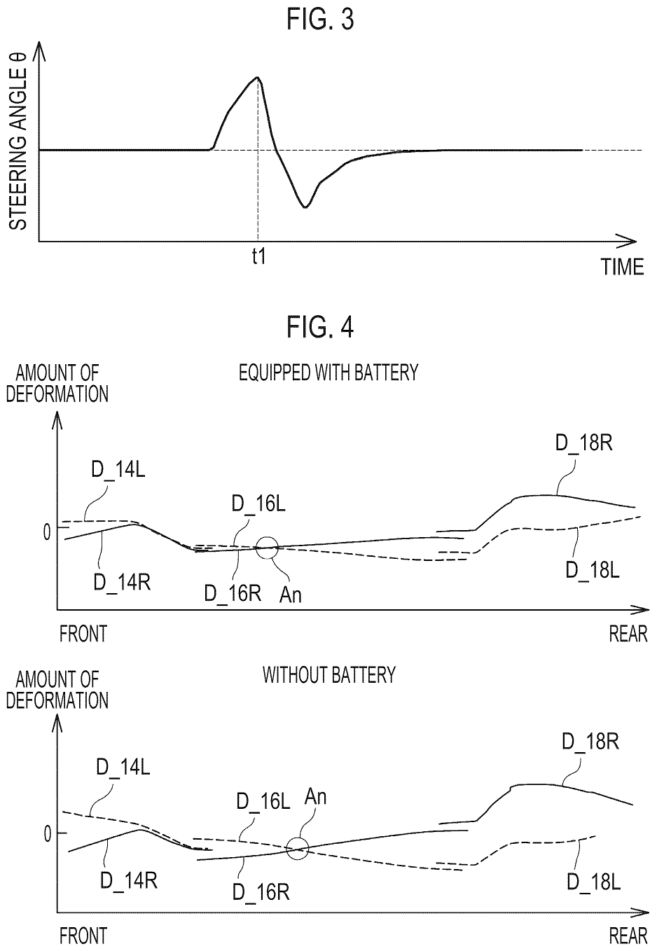

Hereinafter, the determination of the density distribution of the fastening points 40 and the weight balance of the vehicle will be described with reference to FIGS. 3 to 5. The vehicle may be steered while maintaining a high speed (for example, 100 km/h). For example, in a case where the vehicle is lane-changed to the left-side lane, the steering angle θ is first changed greatly in the left direction and then gradually changed in the right direction as shown in FIG. 3, and finally returned to a steering angle θ=0. As the vehicle is steered as described above, torsional deformation occurs in the vehicle body. FIG. 4 is a graph showing an amount of deformation of the frame of the vehicle 10 at the timing t1 at which the steering angle θ is changed most greatly in the left direction.

In FIG. 4, a horizontal axis of each graph indicates a position in the front-rear direction of the vehicle, and a right direction of the paper surface is a rear side of the vehicle. In addition, a vertical axis of each graph indicates the amount of deformation of the frame. In FIG. 4, an upper part shows the amount of deformation of the vehicle equipped with the battery 20, and a lower part shows the amount of deformation of the vehicle without the battery 20. In addition, in each graph, a curve D_14R indicates the amount of deformation of the right front member 14R, and a curve D_14L indicates the amount of deformation of the left front member 14L. Other curves are also denoted in the same manner, with the reference numerals of the corresponding frames following “D_”.

As shown in FIG. 4, the frames 14R, 16R, 18R on the right side of the vehicle and the frames 14L, 16L, 18L on the left side of the vehicle are deformed symmetrically to each other. For example, in the example of FIG. 4, a line connecting the curves D_14R, D_16R, D_18R is inclined upward so as to advance on a plus side as the line approaches the rear side of the vehicle. On the other hand, a line connecting the curves D_14L, D_16L, and D_18L is inclined downward so as to advance on a minus side as the line approaches the rear side of the vehicle. This means that in a case where the vehicle is greatly steered in the left direction or the right direction, torsional deformation occurs in the vehicle body.

The amount of the torsional deformation is smaller in the vehicle equipped with the battery 20 than in the vehicle without the battery 20. This is considered to be because the rigidity of the vehicle is improved by fastening the battery 20 to the rockers 16R, 16L and the cross members. However, even in a case where the rigidity of the vehicle is increased, it is difficult to reduce the amount of torsional deformation of the vehicle to zero. Then, there is a problem that the driver feels displacement vibration due to the torsional deformation of the vehicle, and thus the comfort of the driver is impaired.

With reference to FIG. 4, there is a point at which curve D_16R, curve D_16L intersect. The intersection point is a node An of the torsional deformation. The node An moves forward and backward depending on the rigidity balance of the vehicle. For example, in a case where the battery 20 is not provided, the node An is determined by the rigidity balance between the frames and the bodies themselves, and the node An is positioned near the center in the front-rear direction of the vehicle. On the other hand, in a case where the battery 20 is mounted, the node An is separated from the center of the vehicle by a larger distance than the node An in a case where the battery 20 is not provided. This is because the balance of the rigidity between the front and rear sides of the vehicle changes depending on the presence or absence of the battery 20. In other words, the position of the node An of the torsional deformation can be changed by altering the rigidity balance of the vehicle.

Here, even in a case where the vehicle is greatly torsionally deformed, the amount of deformation at the node An is substantially zero. Therefore, in a case where the driver's seat is disposed at the node An, even in a case where the torsional deformation occurs due to the steering, it is possible to minimize the displacement vibration applied to the driver. In particular, in a case where a position in a front-rear direction of a head of the driver and the position in the front-rear direction of the node An match each other, it is possible to effectively prevent the movement of the head of the driver, and thus it is possible to improve the comfort of the driver.

Therefore, in the present example, the rigidity balance of the vehicle is adjusted such that the node An is positioned within the range in the front-rear direction of the seat 22. Specifically, the rigidity of the vehicle on the front side is made substantially equal to the rigidity of the vehicle on the rear side, with the seat 22 as a boundary. In order to achieve such a rigidity balance, in the present example, the density of the fastening points 40 of the battery 20 is changed depending on the location.

Specifically, a plurality of side fastening points 40a are provided at both ends of the battery 20 in the vehicle width direction in order to fasten the battery 20 to the rockers 16R, 16L. In the present example, a density of the side fastening points 40a on a rear side of a center line C in the front-rear direction of the battery 20 is higher than a density of the side fastening points 40a on a front side of the center line C. In other words, an average value of intervals at which the side fastening points 40a are disposed on the rear side of the center line C is smaller than an average value of intervals at which the side fastening points 40a are disposed on the front side of the center line C. With such a configuration, the battery 20 and the rockers 16R, 16L are firmly connected to each other on the rear side of the center line C, and the rigidity of the vehicle is improved. Then, as a result, the node An is further moved to the rear side of the vehicle from the state of the lower part of FIG. 4. Using this principle, in the present example, the density of the side fastening points 40a on the front side and the density of the side fastening points 40a on the rear side are made actively different from each other such that a position in the front-rear direction of the node An of the torsional deformation is within the range in the front-rear direction of the seat 22. By positioning the node An within the range in the front-rear direction of the seat 22, displacement vibration felt by the driver when the vehicle is steered is reduced, thereby maintaining a high level of driver comfort.

In addition, a plurality of front fastening points 40b and rear fastening points 40c are provided at the front end and the rear end of the battery 20, respectively, in order to fasten the battery 20 to the cross members. A load is applied from suspension members (not shown) to the peripheries of the front fastening points 40b and the rear fastening points 40c. In the present example, a density of the front fastening points 40b and rear fastening points 40c is higher than a density of the side fastening points 40a located on the front side of the center line C in the front-rear direction. With such a configuration, the load input from the suspension members is efficiently transmitted to and distributed in the battery 20.

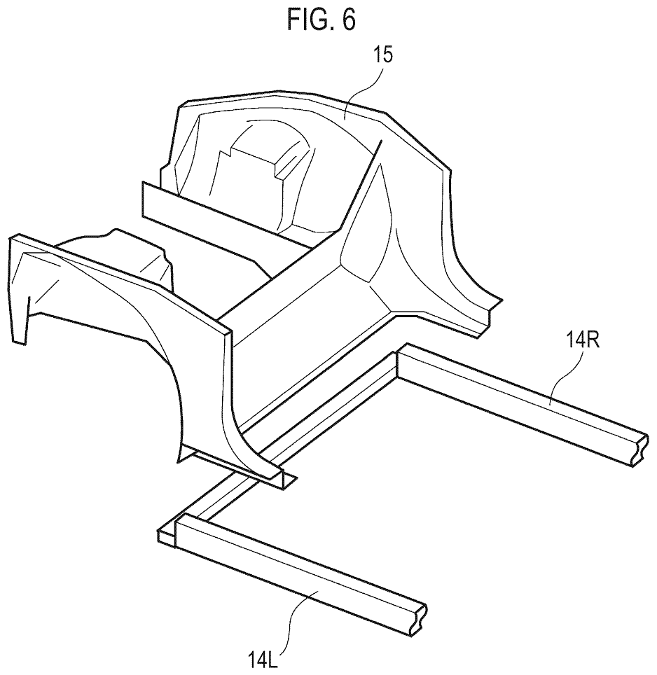

In addition, as shown in FIG. 6, the front body 15 may be formed of a die cast component integrally cast with aluminum. In this case, the front body 15 may be integrally molded with wheel houses. In addition, a part of the front body 15 may further function as the front members 14R, 14L. Similarly, the rear body 19 may be integrally molded with the wheel houses, and a part of the rear body 19 may further function as the rear members 18R, 18L. As described above, by forming the front body 15 and the rear body 19 with die cast components, the rigidity of both the front body 15 and the rear body 19 can be maintained high, and the balance of the rigidity between the front body 15 and the rear body 19 is easily controlled.

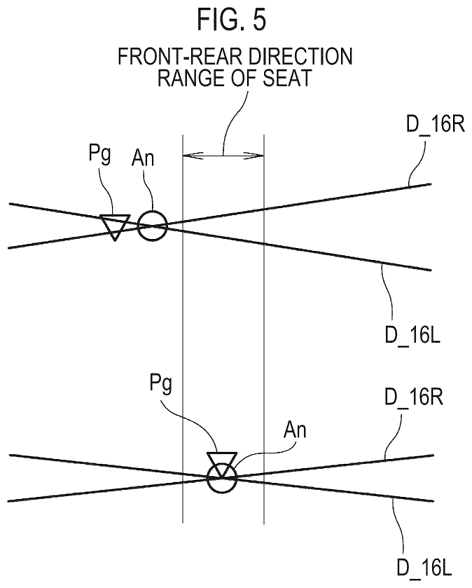

Further, in the present example, the disposition of the on-vehicle components is adjusted such that a position in the front-rear direction of a center of gravity Pg of the vehicle is positioned within the range in the front-rear direction of the seat 22. That is, in the case of a conventional engine vehicle, a heavy object (for example, an engine or the like) is concentrated at the front portion of the vehicle, and the center of gravity Pg is often positioned forward of the seat 22. As a result, in the related art, as shown in the upper part of FIG. 5, the center of gravity Pg of the vehicle was significantly displaced from the seat 22 and the node An, thereby causing an increase in displacement vibrations felt by the driver.

On the other hand, in the case of a battery electric vehicle as in the present example, the large-sized and heavy battery 20 is mounted on the vehicle. By disposing the battery 20 under the floor of the vehicle cabin, a center of gravity Pg is displaced toward the central portion of the vehicle to a greater extent than in the case of a conventional engine vehicle. Further, in the present example, other heavy objects, for example, the transaxle 32 including the motor 30 and the power control unit 34 are disposed behind the seat 22. In the present example, the positions of these heavy objects are adjusted such that the position in the front-rear direction of the center of gravity Pg substantially coincides with the position in the front-rear direction of the seat 22, and consequently, with the position in the front-rear direction of the node An.

As a result, as shown in the lower part of FIG. 5, the positions in the front-rear direction of the seat 22 (and the driver), the node An, and the center of gravity Pg match each other, and thus displacement vibration felt by the driver can be further reduced.

It should be noted that the configurations described so far are merely examples, and the other configurations may be appropriately changed as long as the configuration of claim 1 is provided.

What is claimed is:

1. A vehicle wherein a rigidity balance between a front and a rear of the vehicle is adjusted such that a node of torsional deformation that occurs when the vehicle is steered is positioned within a range of a driver's seat assembly in a vehicle front-rear direction.

2. The vehicle according to claim 1, wherein a weight balance between the front and the rear of the vehicle is adjusted such that a position of a center of gravity of the vehicle in the vehicle front-rear direction is positioned within the range of the driver's seat assembly in the vehicle front-rear direction.

3. The vehicle according to claim 1, further comprising a battery that is disposed under a floor of the vehicle, wherein:
a plurality of side fastening points for fastening the battery to a frame of the vehicle is provided at both ends of the battery in a vehicle width direction; and
a density of the side fastening points rearward of a center of the battery in the vehicle front-rear direction is higher than a density of the side fastening points forward of the center of the battery in the vehicle front-rear direction.

4. The vehicle according to claim 3, wherein:
a plurality of front fastening points and a plurality of rear fastening points for fastening the battery to the frame of the vehicle are provided at a front end and a rear end of the battery, respectively; and
a density of the front fastening points and the rear fastening points is higher than the density of the side fastening points forward of the center of the battery in the vehicle front-rear direction.

5. The vehicle according to claim 1, further comprising:
a front body that includes a pair of wheel houses and is integrally molded by casting;
a rear body that includes a pair of wheel houses and is integrally molded by casting;
a battery that is disposed under a floor of the vehicle; and
a motor that is disposed rearward of the driver's seat assembly.
